(19) United States
(12) Patent Application Publication
(10) Pub. No.: US 2026/0124598 A1
(43) Pub. Date: May 7, 2026

(54) REMOVAL OF PERFLUOROALKYL AND POLYFLUOROALKYL SUBSTANCES FROM WATER USING SIZED-SORBENT MATERIALS

(71) Applicant: CALGON CARBON CORPORATION, Moon Township, PA (US)

(72) Inventors: Adam M. REDDING, State College, PA (US); Richard A. MIMNA, Oakdale, PA (US)

(73) Assignee: CALGON CARBON CORPORATION, Moon Township, PA (US)

(21) Appl. No.: 19/382,937

(22) Filed: Nov. 7, 2025

Related U.S. Application Data
(60) Provisional application No. 63/717,645, filed on Nov. 7, 2024.

(51) Int. Cl. B01J 20/20; B01J 20/28; C02F 1/28; C02F 101/36

(52) U.S. Cl. CPC B01J 20/20; B01J 20/28004; C02F 1/281; C02F 2101/36

(57) ABSTRACT

Sorbent materials for the removal of perfluoroalkyl and polyfluoroalkyl substances (PFAS) from drinking water and methods of using the same are disclosed. The sorbent materials are sized using a 20 US mesh and a 40 US mesh and provide improvements in PFAS removal and PFAS capacity as compared to larger sized sorbent materials.

### CROSS-REFERENCE TO RELATED APPLICATIONS

This application claims benefit of and priority to U.S. Provisional Patent Application No. 63/717,645 titled “REMOVAL OF PERFLUOROALKYL AND POLYFLUOROALKYL SUBSTANCES FROM WATER USING SIZED-SORBENT MATERIALS” filed Nov. 7, 2024, the disclosure of which is incorporated by reference herein in its entirety.

### BACKGROUND

Perfluoroalkyl and polyfluoroalkyl substances (PFAS) are a group of compounds that include perfluorooctanoic acid (PFOA), perfluorooctanesulfonic acid (PFOS), and compounds produced by the GENX process such as 2,3,3,3,-tetrafluoro-2-(heptafluoropropoxy)propanoate and heptafluoropropyl 1,2,2,2-tetrafluoroethyl ether. Such highly fluorinated compounds enjoyed widespread industrial use for many years, owing to their chemical durability, excellent surfactant properties, and key role as precursors to fluoropolymers including polytetrafluoroethylene.

Unfortunately, these same properties render PFAS resistant to degradation in the environment, while simultaneously leading to bioaccumulation when ingested over time. Some recent studies have linked PFAS to various detrimental health effects, most notably elevated levels of cholesterol, but also kidney cancer, testicular cancer, thyroid disease, and pregnancy-induced hypertension.

To date, several technologies have been employed to remove PFAS compounds from the environment and from drinking water. PFAS removal has typically been accomplished with granular activated carbon (GAC) in a range of mesh sizes between 8×16 and 12×40 US Mesh. PFAS can also be removed from a reverse osmosis reject waste stream using granular activated carbon. Additionally, anion exchange resins previously used for perchlorate removal have demonstrated success at removing the similarly negatively charged carboxylate and sulfonate PFAS. PFAS removal via GAC appears to be particularly sensitive to hydraulic loading rate (i.e., contact time), which suggests that diffusion rate into the GAC structure is a controlling factor. In other words, when GAC has more contact time with the water to be treated, the PFAS removal typically improves. There is continued need for performance improvements so that the GAC is even more effective at removing PFAS compounds from the environment and from drinking water.

### SUMMARY

In one embodiment, a method of removing perfluoroalkyl and polyfluoroalkyl substances (PFAS) from liquid or gas includes providing a sorbent material having a particle size between 0.4 mm and 0.85 mm; and contacting the sorbent material with a liquid or gas containing the PFAS.

In some embodiments, the sorbent material includes one or more of carbonaceous char, activated carbon, reactivated carbon, and carbon black.

In some embodiments, the sorbent material is formed from one or more of bituminous coal, sub-bituminous coal, lignite coal, anthracite coal, wood, wood chips, sawdust, peat, nut shells, pits, coconut shell, babassu nut, macadamia nut, dende nut, peach pit, cherry pit, olive pit, walnut shell, wood, lignin, polymers, nitrogen-containing polymers, resins, petroleum pitches, bagasse, rice hulls, corn husks, wheat hulls and chaff, graphenes, carbon nanotubes, or polymer fibers.

In some embodiments, the sorbent material includes an iodine number greater than 1000 mg/g.

In some embodiments, the sorbent material includes an iodine number of at least 1030 mg/g.

In some embodiments, the sorbent material includes a molasses number of at least 175.

In some embodiments, the sorbent material includes an apparent density of less than 0.58 g/cc.

In some embodiments, the sorbent material includes a D50 particle size of 0.6 mm to 0.7 mm.

In some embodiments, the sorbent material is provided as a granular activated carbon, the method further including screening the granular activated carbon using a 20 US mesh and a 40 US mesh.

In some embodiments, the PFAS include one or more of perfluorobutanoic acid, perfluoropentanoic acid, perfluorohexanoic acid, perfluoroheptanoic acid, perfluorooctanoic acid, and perfluorononanoic acid.

In some embodiments, the PFAS include one or more of perfluorobutane sulfonate, perfluoropentane acid, perfluorohexane sulfonate, perfluoroheptane sulfonate, and perfluorooctane sulfonate.

### BRIEF DESCRIPTION OF DRAWINGS

FIG. 1 depicts a diagram of an illustrative method of removing PFAS from a liquid or gas in accordance with an embodiment.

FIGS. 2-23 depict graphical representations of the removal of PFAS from water by sized sorbent materials in accordance with an embodiment.

### DEFINITIONS

As used herein, the term “about” when immediately preceding a numerical value means a range of plus or minus 10% of that value, for example, “about 50” means 45 to 55, “about 25,000” means 22,500 to 27,500, etc., unless the context of the disclosure indicates otherwise, or is inconsistent with such an interpretation.

As used herein, the term “fresh sorbent media” means a sorbent material that contains sorbent capacity. For example, a fresh sorbent media may comprise a virgin activated carbon.

As used herein, the term “spent sorbent media” means a sorbent material that has used all or essentially all of its sorbent capacity.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only and is not intended to be limiting.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.” As used herein, the term “perfluoroalkyl and polyfluoroalkyl substances (PFAS)” means any perfluoroalkyl or polyfluoroalkyl substance, mixture of such substances, or derivative of one or more such substances. Examples of PFAS include perfluoroalkyl sulfonate, perfluoroalkane sulfonic acid (PFSA), N-Butyl perfluoroalkane sulfonamide (BuFASA), N-Butyl perfluoroalkane sulfonamido ethanols (BuFASE), N-Butyl perfluoroalkane sulfonamido acetic acid (BuFASAA), N-Ethyl perfluoroalkane sulfonamide (EtFASA), N-Ethyl perfluoroalkane sulfonamido ethanol (EtFASE), N-Ethyl perfluoroalkane sulfonamido acetic acid (EtFASAA), perfluoroalkane sulfonamide (FASA), perfluoroalkane sulfonamido ethanol (FASE), perfluoroalkane sulfonamido acetic acid (FASAA), N-Methyl perfluoroalkane sulfonamide (MeFASA), N-Methyl perfluoroalkane sulfonamido acetic acid (MeFASAA), N-Methyl perfluoroalkane sulfonamido ethanol (MeFASE), N-Methyl perfluorooctane sulfonamide (MeFOSA), perfluoroalkane sulfonyl fluoride (PASF), 4,8-dioxa-3H-perfluorononanoate, ammonium perfluorooctanoate (APFO), fluoroprotein (FP), fluorotelomer carboxylic acid (FTCA), fluorotelomer alcohol (FTOH), fluorotelomer sulfonate (FTS), fluorotelomer sulfonic acid (FTSA), perfluoroalkyl acid (PFAA), perfluoroalkylsulfonamidoethanol (PFOSE), and any derivatives thereof. These derivatives include, for example and without limitation, perfluorooctanoic acid (PFOA), perfluorooctane sulfonate, perfluorooctanesulfonic acid (PFOS), 2,3,3,3,-tetrafluoro-2-(heptafluoropropoxy)propanoate, ammonium 2,3,3,3-tetrafluoro-2-(heptafluoropropoxy)propanoate, 1,2,2,2-tetrafluoroethyl ether, 4:2-fluorotelomersulfonic acid (4:2 FtS), 6:2-fluorotelomersulfonic acid (6:2 FtS), 8:2-fluorotelomersulfonic acid (8:2 FtS), perfluorobutanoic acid (PFBA), perfluorobutane sulfonate, perfluorobutane sulfonic acid (PFBS), perfluorohexane sulfonate, perfluorohexane sulfonic acid (PFHxS), perfluorohexanoate, perfluorohexanoic acid (PFHxA), 4,8-dioxa-3H-perfluorononanoate, ammonium perfluorooctanoate (APFO), N-Ethyl perfluorooctane sulfonamide (EtFOSA), N-Ethyl perfluorooctane sulfonamido ethanol (EtFOSE), perfluorooctane sulfonamide (PFOSA), perfluorooctane sulfonamido acetic acid (FOSAA), perfluorooctane sulfonamido ethanol (FOSE), perfluorobutanoate, perfluorobutanoic acid, perfluorobutyrate, perfluorobutyric acid, perfluoroalkyl carboxylate, perfluoroalkyl carboxylic acid (PFCA), perfluorodecanoate, perfluorodecanoic acid (PFDA), perfluorododecanoate, perfluorododecanoic acid (PFDoA), perfluorododecane sulfonate (PFDoS), perfluorododecane sulfonic acid (PFDoSA), perfluorodecane sulfonate, perfluorodecane sulfonic acid (PFDS), perfluoroheptanoate, perfluoroheptanoic acid (PFHpA), perfluoroheptane sulfonate, perfluoroheptane sulfonic acid (PFHpS), perfluorononanoate, perfluorononanoic acid (PFNA), perfluorononane sulfonate, perfluorononane sulfonic acid (PFNS), perfluorooctanoate, perfluorophosphonic acid (PFPA), perfluoropentanoate, perfluoropentanoic acid (PFPeA), perfluoropentane sulfonate, perfluoropentane sulfonic acid (PFPeS), perfluorophosphinic acid (PFPiA), perfluorotetradecanoic acid (PFTeDA), perfluorotridecanoic acid (PFTrDA), perfluoroundecanoate, perfluoroundecanoic acid (PFUnA), perfluoroundecane sulfonate (PFUnS), perfluoroundecane sulfonic acid (PFUnSA), or polytetrafluoroethylene (PTFE).

As used herein, the term “20×40” refers to the mesh size used to sieve a sorbent material. For example, a sorbent material with a mesh size of 20×40 comprises material sieved between a 20 US Mesh and a 40 US Mesh.

While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” etc.). It will be further understood by those skilled in the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 compounds. Similarly, a group having 1-5 compounds refers to groups having 1, 2, 3, 4, or 5 compounds, and so forth.

### DETAILED DESCRIPTION

This disclosure is not limited to the particular systems, devices, and methods described, as these may vary. The terminology used in the description is for the purpose of describing the particular versions or embodiments only and is not intended to limit the scope.

### Product

Carbon products may be assembled for the removal of perfluoroalkyl and polyfluoroalkyl substances (PFAS) from a liquid or gas using a sorbent material. In some embodiments, the sorbent material comprises a particle diameter sieved between a 20 US Mesh and a 40 US Mesh (20×40). In some embodiments, the sorbent material has a particle diameter between 0.4 mm and 0.85 mm. In some embodiments, the sorbent material comprises granular activated carbon. The use of the sorbent material with a smaller particle size provides a higher capacity for PFAS removal as compared to the same sorbent material with a larger particle size.

The sorbent material may be any material effective for the removal of contaminants from a fluid known to one of skill in the art. In some embodiments, the sorbent material comprises one or more of carbonaceous char, activated carbon, reactivated carbon, carbon black, natural and synthetic zeolite, silica, silica gel, alumina, alumina clay, zirconia, diatomaceous earths, or metal oxides. In some embodiments, the sorbent material is activated carbon or reactivated carbon. In such embodiments, the activated or reactivated carbon is prepared from any precursor carbonaceous material known in the art including, but not limited to, bituminous coal, sub-bituminous coal, lignite coal, anthracite coal, wood, wood chips, sawdust, peat, nut shells, pits, coconut shell, babassu nut, macadamia nut, dende nut, peach pit, cherry pit, olive pit, walnut shell, wood, lignin, polymers, nitrogen-containing polymers, resins, petroleum pitches, bagasse, rice hulls, corn husks, wheat hulls and chaff, graphenes, carbon nanotubes, polymer fibers, or any other carbonaceous material or any combination thereof. In some embodiments, the carbonaceous material may be derived from activated carbons produced from various precursors that have been in-use and subsequently reactivated and/or regenerated. In some embodiments, the sorbent material feedstock is provided in a preoxidized state. In other embodiments, the sorbent material feedstock is provided in an unoxidized state.

In some embodiments, the sorbent material has a D50 particle size of about 0.40 mm, about 0.41 mm, about 0.42 mm, about 0.43 mm, about 0.44 mm, about 0.45 mm, about 0.46 mm, about 0.47 mm, about 0.48 mm, about 0.49 mm, about 0.50 mm, about 0.51 mm, about 0.52 mm, about 0.53 mm, about 0.54 mm, about 0.55 mm, about 0.56 mm, about 0.57 mm, about 0.58 mm, about 0.59 mm, about 0.60 mm, about 0.61 mm, about 0.62 mm, about 0.63 mm, about 0.64 mm, about 0.65 mm, about 0.66 mm, about 0.67 mm, about 0.68 mm, about 0.69 mm, about 0.70 mm, about 0.71 mm, about 0.72 mm, about 0.73 mm, about 0.74 mm, about 0.75 mm, about 0.76 mm, about 0.77 mm, about 0.78 mm, about 0.79 mm, about 0.80 mm, or any values or range of value between any two of these values. In some embodiments, the sorbent material has a D50 particle size of about 0.60 mm to about 0.80 mm or about 0.60 mm to about 0.70 mm. In some embodiments, the sorbent material has a D50 particle size of about 0.40 mm to about 0.80 mm, about 0.40 mm to about 0.75 mm, about 0.40 mm to about 0.70 mm, about 0.40 mm to about 0.65 mm, or about 0.40 mm to about 0.60 mm.

The sorbent material may comprise any iodine number effective for the removal of contaminants from a fluid. In some embodiments, the sorbent material comprises an iodine number of about 600 mg/g, about 610 mg/g, about 620 mg/g, about 630 mg/g, about 640 mg/g, about 650 mg/g, about 660 mg/g, about 670 mg/g, about 680 mg/g, about 690 mg/g, about 700 mg/g, about 710 mg/g, about 720 mg/g, about 730 mg/g, about 740 mg/g, about 750 mg/g, about 760 mg/g, about 770 mg/g, about 780 mg/g, about 790 mg/g, about 800 mg/g, about 810 mg/g, about 820 mg/g, about 830 mg/g, about 840 mg/g, about 850 mg/g, about 860 mg/g, about 870 mg/g, about 880 mg/g, about 890 mg/g, about 900 mg/g, about 910 mg/g, about 920 mg/g, about 930 mg/g, about 940 mg/g, about 950 mg/g, about 960 mg/g, about 970 mg/g, about 980 mg/g, about 990 mg/g, about 1000 mg/g, about 1005 mg/g, about 1010 mg/g, about 1015 mg/g, about 1020 mg/g, about 1025 mg/g, about 1030 mg/g, about 1035 mg/g, about 1040 mg/g, about 1045 mg/g, about 1050 mg/g, about 1060 mg/g, about 1070 mg/g, about 1080 mg/g, about 1090 mg/g, about 1100 mg/g, about 1110 mg/g, about 1120 mg/g, about 1130 mg/g, about 1140 mg/g, about 1150 mg/g, about 1160 mg/g, about 1170 mg/g, about 1180 mg/g, about 1190 mg/g, about 1200 mg/g, about 1210 mg/g, about 1220 mg/g, about 1230 mg/g, about 1240 mg/g, about 1250 mg/g, about 1260 mg/g, about 1270 mg/g, about 1280 mg/g, about 1290 mg/g, about 1300 mg/g, about 1310 mg/g, about 1320 mg/g, about 1330 mg/g, about 1340 mg/g, about 1350 mg/g, about 1360 mg/g, about 1370 mg/g, about 1380 mg/g, about 1390 mg/g, about 1400 mg/g, about 1410 mg/g, about 1420 mg/g, about 1430 mg/g, about 1440 mg/g, about 1450 mg/g, about 1460 mg/g, about 1470 mg/g, about 1480 mg/g, about 1490 mg/g, about 1500 mg/g, or any value or range of values between any two of these values. In some embodiments, the sorbent material comprises an iodine number of at least about 600 mg/g, at least about 800 mg/g, at least about 1000 mg/g, at least about 1030 mg/g, at least about 1100 mg/g, at least about 1200 mg/g, at least about 1300 mg/g or at least about 1400 mg/g.

The sorbent material may comprise any molasses number effective for the removal of contaminants from a fluid. In some embodiments, the sorbent material comprises a molasses number of about 150, about 151, about 152, about 153, about 154, about 155, about 156, about 157, about 158, about 159, about 160, about 161, about 162, about 163, about 164, about 165, about 166, about 167, about 168, about 169, about 170, about 171, about 172, about 173, about 174, about 175, about 175, about 177, about 178, about 179, about 180, about 181, about 182, about 183, about 184, about 185, about 186, about 187, about 188, about 189, about 190, about 195, about 200, about 250, about 300, about 350, about 400, about 450, about 500, about 550, about 600, about 650, about 700, about 750, about 800, about 850, about 900, or any value or range of values between any two of these values. In some embodiments, the sorbent material comprises a molasses number of at least about 170, at least about 175, at least about 180, at least about 185, or at least about 190.

The sorbent material may comprise any apparent density effective for the removal of contaminants from a fluid. In some embodiments, the sorbent material comprises an apparent density of about 0.58 g/cc, about 0.575 g/cc, about 0.57 g/cc, about 0.565 g/cc, about 0.56 g/cc, about 0.555 g/cc, about 0.55 g/cc, about 0.545 g/cc, about 0.54 g/cc, about 0.535 g/cc, about 0.53 g/cc, 0.52 g/cc, about 0.51 g/cc, about 0.50 g/cc, about 0.49 g/cc, about 0.48 g/cc, about 0.47 g/cc, about 0.46 g/cc, about 0.45 g/cc, about 0.44 g/cc, about 0.43 g/cc, about 0.42 g/cc, about 0.41 g/cc, about 0.40 g/cc, 0.39 g/cc, about 0.38 g/cc, about 0.37 g/cc, about 0.36 g/cc, about 0.35 g/cc, or any values or range of value between any two of these values. In some embodiments, the sorbent material comprises an apparent density of about 0.38 g/cc to about 0.58 g/cc, about 0.50 g/cc to about 0.57 g/cc, about 0.50 g/cc to about 0.56 g/cc, about 0.50 g/cc to about 0.54 g/cc, or about 0.50 g/cc to about 0.53 g/cc. In some embodiments, the sorbent material comprises an apparent density of less than about 0.58 g/cc.

### Method of Use

Methods may be performed to remove contaminants from a fluid.

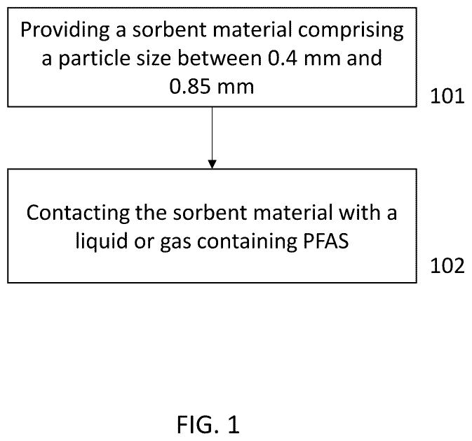

FIG. 1 depicts a diagram of an illustrative method of removing perfluoroalkyl and polyfluoroalkyl substances (PFAS) from liquid or gas. The method comprises providing 101 a sorbent material comprising a particle size between 0.4 mm and 0.85 mm. The sorbent material may be any material effective for the removal of contaminants from a fluid and known to one of skill in the art. In some embodiments, the sorbent material comprises one or more of carbonaceous char, activated carbon, reactivated carbon, carbon black, natural and synthetic zeolite, silica, silica gel, alumina, alumina clay, zirconia, diatomaceous earths, or metal oxides. In some embodiments, the sorbent material comprises granular activated carbon (GAC). In some embodiments, the sorbent material comprises 20×40 GAC. In some embodiments, the method may comprise providing 101 a sorbent material and screening the sorbent material using a 20 US mesh and a 40 US mesh to form a 20×40 sorbent material. In some embodiments, the method may comprise providing 101 a granular activated carbon and screening the granular activated carbon using a 20 US mesh and a 40 US mesh to form a 20×40 GAC. Surprisingly, the use of 20×40 GAC provided improved PFAS removal as compared to larger sorbent materials. The 20×40 GAC provided a higher PFAS adsorption capacity than larger sorbent materials by allowing for more rapid diffusion of the PFAS compounds into the GAC pore structure. Furthermore, the 20×40 GAC surprisingly provided an increase in bed volumes to breakthrough of PFAS as compared to larger sorbent materials.

In some embodiments, the sorbent material is activated carbon or reactivated carbon. In such embodiments, the activated or reactivated carbon is prepared from any precursor carbonaceous material known in the art including, but not limited to, bituminous coal, sub-bituminous coal, lignite coal, anthracite coal, wood, wood chips, sawdust, peat, nut shells, pits, coconut shell, babassu nut, macadamia nut, dende nut, peach pit, cherry pit, olive pit, walnut shell, wood, lignin, polymers, nitrogen-containing polymers, resins, petroleum pitches, bagasse, rice hulls, corn husks, wheat hulls and chaff, graphenes, carbon nanotubes, polymer fibers, or any other carbonaceous material or any combination thereof. In some embodiments, the carbonaceous material may be derived from activated carbons produced from various precursors that have been in-use and subsequently reactivated and/or regenerated. In some embodiments, the sorbent material feedstock is provided 101 in a preoxidized state. In other embodiments, the sorbent material feedstock is provided 101 in an unoxidized state.

In some embodiments, the method may further comprise contacting 102 the sorbent material with a liquid or gas containing the PFAS. In some embodiments, the PFAS comprise one or more of perfluorobutanoic acid, perfluoropentanoic acid, perfluorohexanoic acid, perfluoroheptanoic acid, perfluorooctanoic acid, and perfluorononanoic acid. In some embodiments, the PFAS comprises one or more of perfluorobutane sulfonate, perfluoropentane acid, perfluorohexane sulfonate, perfluoroheptane sulfonate, and perfluorooctane sulfonate.

The sorbent materials of the disclosure are useful whenever it is necessary to remove PFAS, PFOA, PFOS or chemically similar or chemically related compounds from liquids and/or gases, including water. The removal of such compounds may be performed in advance of human or animal consumption or for environmental remediation. Specific applications include point of use filters, point of entry filters, portable filters, municipal drinking water filtration, municipal waste filtration, and industrial waste filtration. In some embodiments, the sorbent materials of the disclosure are used alone, without any other sorbent materials. In some embodiments, the sorbent materials of the disclosure are used in combination with other sorbent materials.

Although the sorbent materials of the disclosure are primarily disclosed as removing PFAS, PFOA, PFOS, or chemically similar or chemically related compounds, the use of the sorbent materials is not so limited. In still further embodiments, the sorbent materials are suitable for removing any compounds and/or byproducts that cause taste and odor problems in water. Such compounds are referred to as “taste and odor compounds” throughout the application. Examples of such taste and odor compounds include one or more of trans-1, 10-dimethyl-trans-9-decalol (“Geosmin”), 2-methylisoborneol (MIB), isopropylmethoxypyrazine (IPMP), isobutylmethoxypyrazine (IBMP), methyl tertiary butyl ether (MTBE), 2,4-heptadienal, decandienal, octanal, chlorine, chloramine, chlorophenols, iodoform, hydrocarbons, volatile organic compounds (VOCs), iron, iron oxides, copper, copper oxides, zinc, zinc oxides, manganese, and manganese oxides.

In some embodiments, the sorbent materials are provided within a container. The container holds the sorbent materials and allows the liquid or gas to flow on or through the container, thus bringing the liquid or gas in contact with the sorbent materials. In some embodiments, the container is a permanent container that is installed within a device or process facility and connected by piping or other fluid conduits so that the liquid or gas flows through the container. From time to time, the spent sorbent materials are emptied from the container and replaced by virgin sorbent materials and/or reactivated sorbent materials in order to ensure that the sorbent materials remain effective in removing PFAS, PFOA, PFOS, or chemically similar or chemically related compounds from liquid or gas that flows through the container. The physical form of the sorbent materials within the container is not limited, and the sorbent materials can be provided loose (alone) or formed as a cartridge with other structural materials that hold it in place or which are mixed as a binder. In some embodiments, the sorbent materials are backwashed in the container to maximize the bed life of the sorbent material. The use of a sorbent having a smaller particle size, such as 20×40 GAC, provides an advantage over a larger particle size because the smaller particle sized sorbent fluidizes easier with a reduced backwash flow.

In some embodiments, the container itself is designed to be replaced rapidly and with minimal change to outside components such as pumps and conduits that convey the liquids or gases to the container. In such embodiments, the container is referred to as a “cartridge,” and it can be connected and disconnected from surrounding components. In some embodiments, the cartridge is disposable, such as in consumer drinking water applications. In other embodiments, the cartridge is intended to be refurbished, with the cartridge containing spent sorbent returned for cleaning or reactivation of the sorbent material, refilled with fresh virgin or reactivated sorbent material, and returned to service following completion of the refurbishing operation.

The above sorbent materials may be used alone or in combination with other materials. In some embodiments, a composition is formed where a sorbent material is combined with a binder and molded, extruded, or otherwise formed into shapes or pellets. The binder is not limited and may include one or more of an inorganic binder and an organic binder. Illustrative inorganic binders include metals, ceramics, clays, glasses, or combinations of one or more of the above. Illustrative organic binders include petroleum resins and/or pitches, natural resins and/or pitches, polymers, or combinations of one or more of the above.

### EXAMPLES

### Example 1: Testing Properties of 20×40 GAC

Resizing was performed on a FILTRASORB 400 (F400) Carbon. Such materials are available from Calgon Carbon Corp. of Moon Township, PA. FILTRASORB F400 is a coal-based granular activated carbon having 2 wt. % maximum moisture, an effective size of about 0.55 mm to about 0.75 mm, and an apparent density of about 0.54 g/cm³. The resizing procedure began with the homogenization of a portion of the bulk F400 sample via riffling. A bulk F400 sample was collected for analytical testing following the homogenization. For the preparation of the 20×40 mesh F400, screen sizes 20 mesh, 40 mesh, and a pan were used in a large Gilson Screen Shaker. One scoop of bulk F400 sample (150-200 g) was loaded into the shaker. The shaker was run for 3 minutes. The 20×40 sample collected from the screen was retained in a closed bucket. The bulk F400 sample and 20×40 mesh sample were tested for apparent density (AD), ash content, iodine number, molasses number, and trace capacity number. The results are listed in Table 1 alongside the FILTRASORB F400 product specs.

TABLE 1

| | SAMPLE | | PRODUCT SPECS | |
|---|---|---|---|---|
| TEST | F400 Bulk | 20 × 40 Mesh | FILTRASORB 400 | UNITS |
| AD | 0.5826 | 0.556 | — | g/cc |
| Ash | 7.5 | 7.5 | 11 (max) | % |
| I2# | 1000 | 1027 | 1000 (min) | mg/g |
| Molasses# | 167 | 175 | — | — |
| TCN | 13.8 | 13.3 | — | g/100 cc |
| TCN-G | 5.9 | 5.8 | — | mg/cc |

The results of the testing show that the 20×40 Mesh had a higher iodine number and molasses number than the F400 Bulk sample while achieving a lower apparent density.

### Example 2: Removal of Perfluorobutanoic Acid (PFBA)

A column of granulated activated carbon (GAC) was constructed to test for the adsorption of PFAS compounds. A sample of 20×40 F400 GAC was prepared as described in Example 1. A sample of 12×40 F400 GAC was also prepared using the same method as described in Example 1 except using a 12 US Mesh in place of the 20 US Mesh.

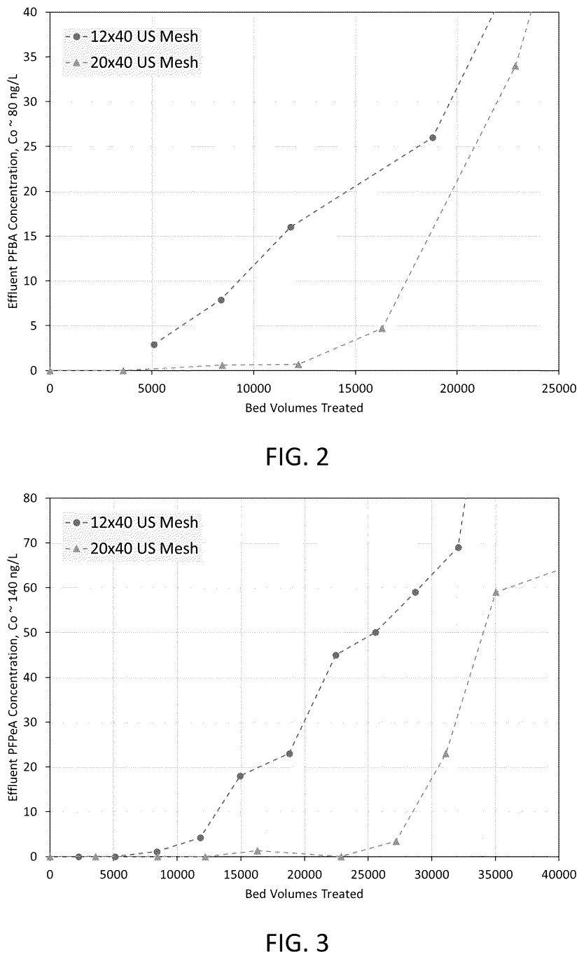

A PFAS adsorption test was performed using a pilot column to generate a PFBA breakthrough curve. The inlet concentration of PFBA was about 80 ng/L, and data was logged to yield a breakthrough curve. Breakthrough was measured as the concentration in ng/L that broke through a column of 12×40 F400 GAC or 20×40 F400 GAC. FIG. 2 displays the measured amounts of PFBA in the water. The results of the testing show a clear improvement in the number of beds to breakthrough the 20×40 F400 GAC as compared to the 12×40 F400 GAC. The 20×40 F400 GAC had an initial breakthrough at about 16,000 bed volumes while the 12×40 F400 GAC had an initial breakthrough at about 5,000 bed volumes.

### Example 3: Removal of Perfluoropentanoic Acid (PFPeA)

A column of granulated activated carbon (GAC) was constructed to test for the adsorption of PFAS compounds. A sample of 20×40 F400 GAC was prepared as described in Example 1. A sample of 12×40 F400 GAC was prepared using the same method as described in Example 2.

A PFAS adsorption test was performed using a pilot column to generate a PFPeA breakthrough curve. The inlet concentration of PFPeA was about 140 ng/L, and data was logged to yield a breakthrough curve. Breakthrough was measured as the concentration in ng/L that broke through a column of 12×40 F400 GAC or 20×40 F400 GAC. FIG. 3 displays the measured amounts of PFPeA in the water. The results of the testing show a clear improvement in the number of beds to breakthrough the 20×40 F400 GAC as compared to the 12×40 F400 GAC. The 20×40 F400 GAC had an initial breakthrough at about 27,500 bed volumes while the 12×40 F400 GAC had an initial breakthrough at about 9,000 bed volumes.

### Example 4: Removal of Perfluorohexanoic Acid (PFHxA)

A column of granulated activated carbon (GAC) was constructed to test for the adsorption of PFAS compounds. A sample of 20×40 F400 GAC was prepared as described in Example 1. A sample of 12×40 F400 GAC was prepared using the same method as described in Example 2.

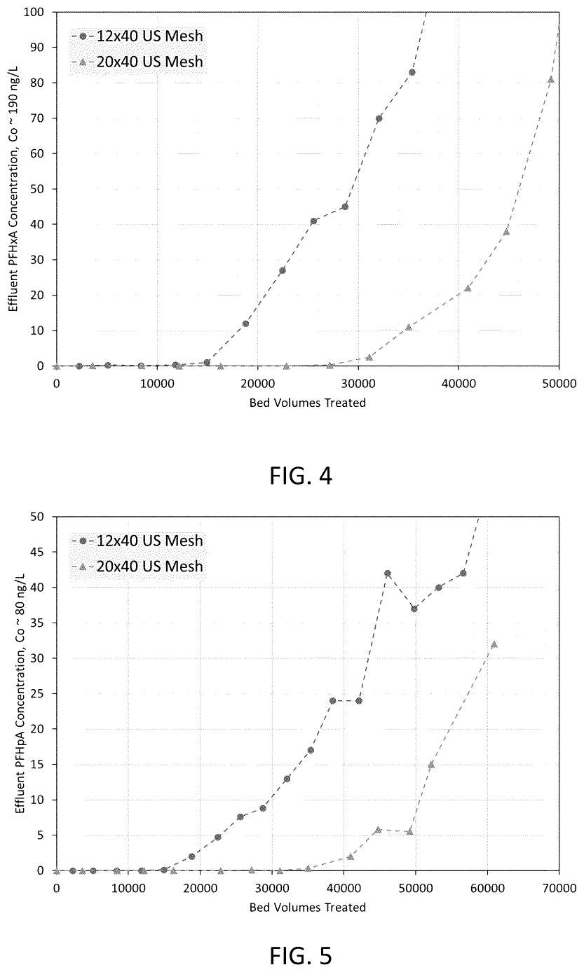

A PFAS adsorption test was performed using a pilot column to generate a PFHxA breakthrough curve. The inlet concentration of PFHxA was about 190 ng/L, and data was logged to yield a breakthrough curve. Breakthrough was measured as the concentration in ng/L that broke through a column of 12×40 F400 GAC or 20×40 F400 GAC. FIG. 4 displays the measured amounts of PFHxA in the water. The results of the testing show a clear improvement in the number of beds to breakthrough the 20×40 F400 GAC as compared to the 12×40 F400 GAC. The 20×40 F400 GAC had an initial breakthrough at about 31,000 bed volumes while the 12×40 F400 GAC had an initial breakthrough at about 19,000 bed volumes.

### Example 5: Removal of Perfluoroheptanoic Acid (PFHpA)

A column of granulated activated carbon (GAC) was constructed to test for the adsorption of PFAS compounds. A sample of 20×40 F400 GAC was prepared as described in Example 1. A sample of 12×40 F400 GAC was prepared using the same method as described in Example 2.

A PFAS adsorption test was performed using a pilot column to generate a PFHpA breakthrough curve. The inlet concentration of PFHpA was about 80 ng/L, and data was logged to yield a breakthrough curve. Breakthrough was measured as the concentration in ng/L that broke through a column of 12×40 F400 GAC or 20×40 F400 GAC. FIG. 5 displays the measured amounts of PFHpA in the water. The results of the testing show a clear improvement in the number of beds to breakthrough the 20×40 F400 GAC as compared to the 12×40 F400 GAC. The 20×40 F400 GAC had an initial breakthrough at about 41,000 bed volumes while the 12×40 F400 GAC had an initial breakthrough at about 19,000 bed volumes.

### Example 6: Removal of Perfluorooctanoic Acid (PFOA)

A column of granulated activated carbon (GAC) was constructed to test for the adsorption of PFAS compounds. A sample of 20×40 F400 GAC was prepared as described in Example 1. A sample of 12×40 F400 GAC was prepared using the same method as described in Example 2.

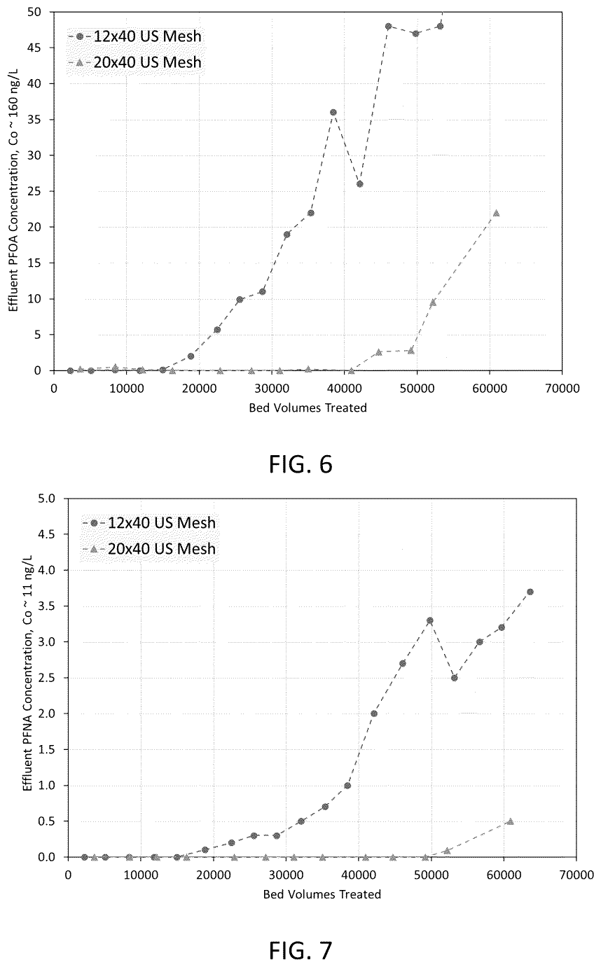

A PFAS adsorption test was performed using a pilot column to generate a PFOA breakthrough curve. The inlet concentration of PFOA was about 160 ng/L, and data was logged to yield a breakthrough curve. Breakthrough was measured as the concentration in ng/L that broke through a column of 12×40 F400 GAC or 20×40 F400 GAC. FIG. 6 displays the measured amounts of PFOA in the water. The results of the testing show a clear improvement in the number of beds to breakthrough the 20×40 F400 GAC as compared to the 12×40 F400 GAC. The 20×40 F400 GAC had an initial breakthrough at about 45,000 bed volumes while the 12×40 F400 GAC had an initial breakthrough at about 19,000 bed volumes.

### Example 7: Removal of Perfluorononanoic Acid (PFNA)

A column of granulated activated carbon (GAC) was constructed to test for the adsorption of PFAS compounds. A sample of 20×40 F400 GAC was prepared as described in Example 1. A sample of 12×40 F400 GAC was prepared using the same method as described in Example 2.

A PFAS adsorption test was performed using a pilot column to generate a PFNA breakthrough curve. The inlet concentration of PFNA was about 11 ng/L, and data was logged to yield a breakthrough curve. Breakthrough was measured as the concentration in ng/L that broke through a column of 12×40 F400 GAC or 20×40 F400 GAC. FIG. 7 displays the measured amounts of PFNA in the water. The results of the testing show a clear improvement in the number of beds to breakthrough the 20×40 F400 GAC as compared to the 12×40 F400 GAC. The 20×40 F400 GAC had an initial breakthrough at about 52,000 bed volumes while the 12×40 F400 GAC had an initial breakthrough at about 19,000 bed volumes.

### Example 8: Removal of Perfluorobutane Sulfonate (PFBS)

A column of granulated activated carbon (GAC) was constructed to test for the adsorption of PFAS compounds. A sample of 20×40 F400 GAC was prepared as described in Example 1. A sample of 12×40 F400 GAC was prepared using the same method as described in Example 2.

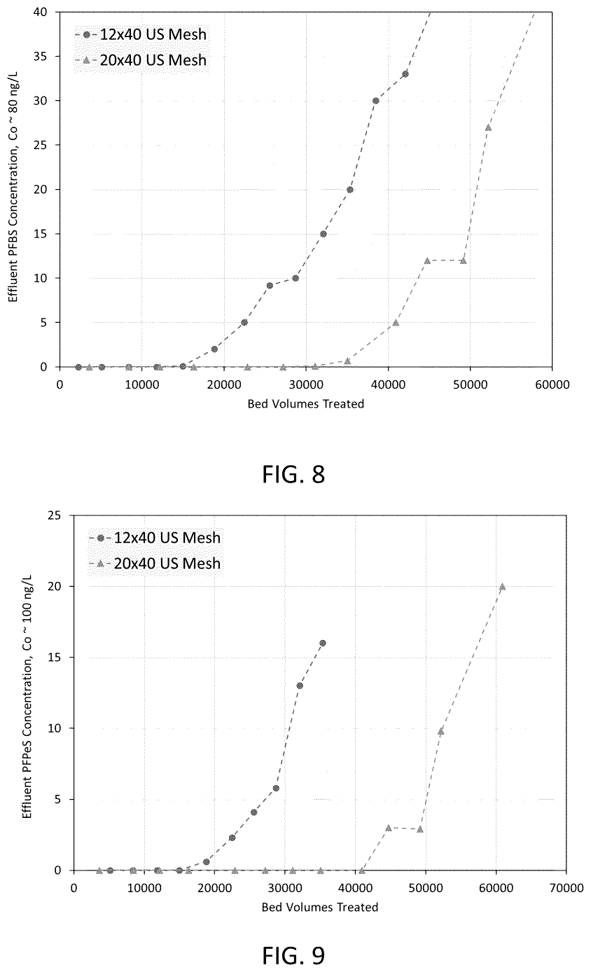

A PFAS adsorption test was performed using a pilot column to generate a PFBS breakthrough curve. The inlet concentration of PFBS was about 80 ng/L, and data was logged to yield a breakthrough curve. Breakthrough was measured as the concentration in ng/L that broke through a column of 12×40 F400 GAC or 20×40 F400 GAC. FIG. 8 displays the measured amounts of PFBS in the water. The results of the testing show a clear improvement in the number of beds to breakthrough the 20×40 F400 GAC as compared to the 12×40 F400 GAC. The 20×40 F400 GAC had an initial breakthrough at about 35,000 bed volumes while the 12×40 F400 GAC had an initial breakthrough at about 19,000 bed volumes.

### Example 9: Removal of Perfluoropentane Sulfonate (PFPeS)

A column of granulated activated carbon (GAC) was constructed to test for the adsorption of PFAS compounds. A sample of 20×40 F400 GAC was prepared as described in Example 1. A sample of 12×40 F400 GAC was prepared using the same method as described in Example 2.

A PFAS adsorption test was performed using a pilot column to generate a PFPeS breakthrough curve. The inlet concentration of PFPeS was about 100 ng/L, and data was logged to yield a breakthrough curve. Breakthrough was measured as the concentration in ng/L that broke through a column of 12×40 F400 GAC or 20×40 F400 GAC. FIG. 9 displays the measured amounts of PFPeS in the water. The results of the testing show a clear improvement in the number of beds to breakthrough the 20×40 F400 GAC as compared to the 12×40 F400 GAC. The 20×40 F400 GAC had an initial breakthrough at about 44,000 bed volumes while the 12×40 F400 GAC had an initial breakthrough at about 19,000 bed volumes.

### Example 10: Removal of Perfluorohexane Sulfonate (PFHxS)

A column of granulated activated carbon (GAC) was constructed to test for the adsorption of PFAS compounds. A sample of 20×40 F400 GAC was prepared as described in Example 1. A sample of 12×40 F400 GAC was prepared using the same method as described in Example 2.

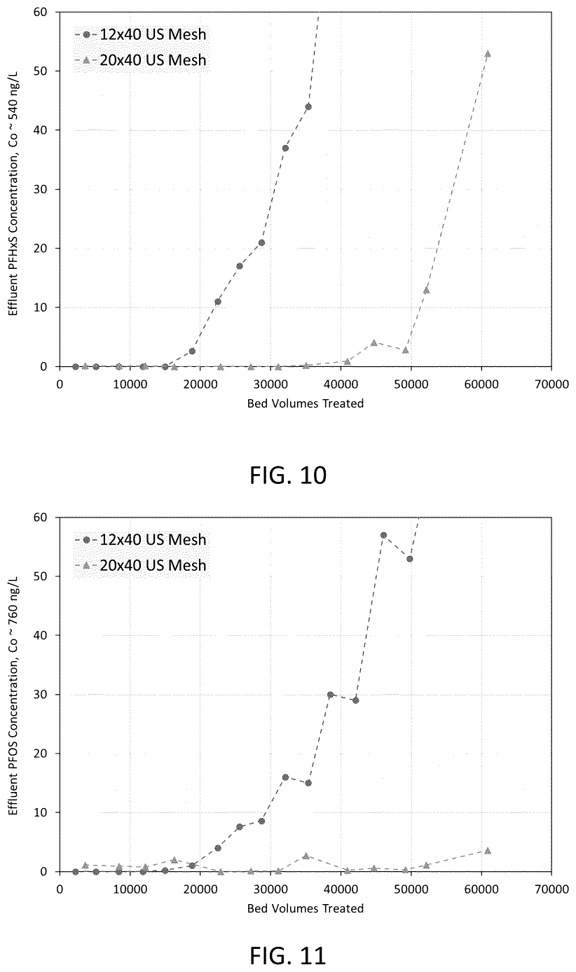

A PFAS adsorption test was performed using a pilot column to generate a PFHxS breakthrough curve. The inlet concentration of PFHxS was about 540 ng/L, and data was logged to yield a breakthrough curve. Breakthrough was measured as the concentration in ng/L that broke through a column of 12×40 F400 GAC or 20×40 F400 GAC. FIG. 10 displays the measured amounts of PFHxS in the water. The results of the testing show a clear improvement in the number of beds to breakthrough the 20×40 F400 GAC as compared to the 12×40 F400 GAC. The 20×40 F400 GAC had an initial breakthrough at about 41,000 bed volumes while the 12×40 F400 GAC had an initial breakthrough at about 19,000 bed volumes.

### Example 11: Removal of Perfluorooctane Sulfonate (PFOS)

A column of granulated activated carbon (GAC) was constructed to test for the adsorption of PFAS compounds. A sample of 20×40 F400 GAC was prepared as described in Example 1. A sample of 12×40 F400 GAC was prepared using the same method as described in Example 2.

A PFAS adsorption test was performed using a pilot column to generate a PFOS breakthrough curve. The inlet concentration of PFOS was about 760 ng/L, and data was logged to yield a breakthrough curve. Breakthrough was measured as the concentration in ng/L that broke through a column of 12×40 F400 GAC or 20×40 F400 GAC. FIG. 11 displays the measured amounts of PFOS in the water. The results of the testing show a clear improvement in the number of beds to breakthrough the 20×40 F400 GAC as compared to the 12×40 F400 GAC. The 20×40 F400 GAC had an initial breakthrough at about 52,000 bed volumes while the 12×40 F400 GAC had an initial breakthrough at about 19,000 bed volumes.

### Example 12: Removal of PFBA

A column of CARBSORB™ granulated activated carbon (GAC) was constructed to test for the adsorption of PFAS compounds. Such materials are available from Calgon Carbon Corp. of Moon Township, PA. CARBSORB™ is a coal-based granular activated carbon having an apparent density of about 0.53 g/cm³. A sample of 20×40 CARBSORB™ GAC was prepared as described in Example 1. A sample of 12×40 CARBSORB™ GAC was prepared using the same method as described in Example 2.

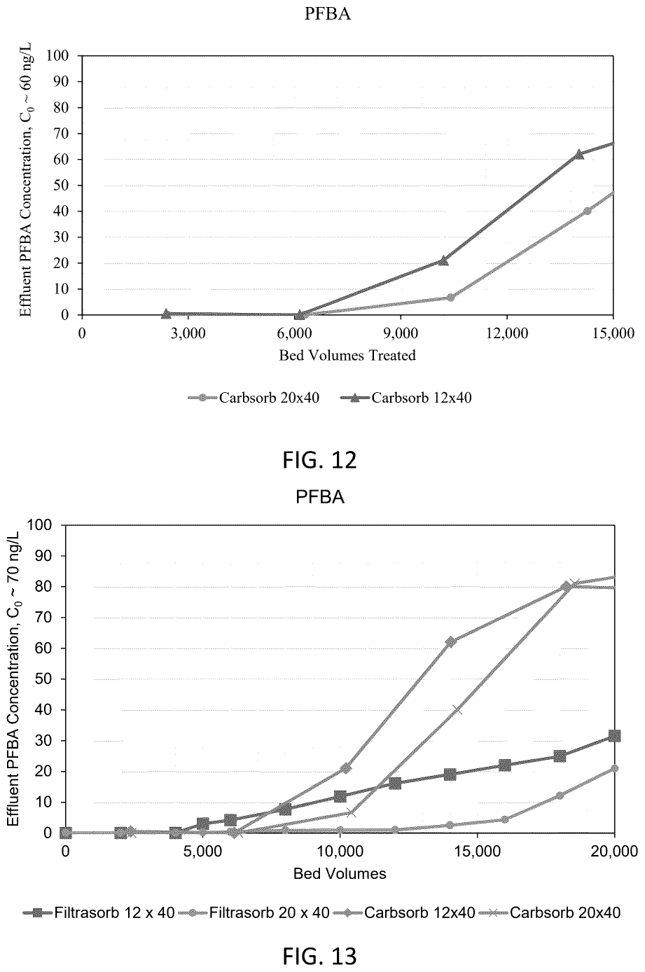

A PFAS adsorption test was performed using a pilot column to generate a PFBA breakthrough curve. The inlet concentration of PFBA was about 60 ng/L, and data was logged to yield a breakthrough curve. Breakthrough was measured as the concentration in ng/L that broke through a column of 12×40 GAC or 20×40 GAC. FIG. 12 displays the measured amounts of PFBA in the water. The results of the testing show a clear improvement in the number of beds to breakthrough the 20×40 GAC as compared to the 12×40 GAC. The 20×40 GAC had an initial breakthrough at about 10,400 bed volumes while the 12×40 GAC had an initial breakthrough at about 10,200 bed volumes.

FIG. 13 displays an overlay of the results of the PFBA breakthrough testing for the CARBSORB™ carbon and the FILTRASORB 400 using the mesh sizes of 12×40 and 20×40. The results of the testing clearly show the improvement in the breakthrough of the PFBA when using the 20×40 GAC as compared to the 12×40 GAC. The results show that each of the 20×40 F400 GAC and the 20×40 CARBSORB™ GAC outperformed the 12×40 F400 GAC and the 12×40 CARBSORB™ GAC samples. This shows the improvement provided by the use of 20×40 GAC in PFAS removal as compared to larger sorbent materials.

### Example 13: Removal of PFPeA

A column of CARBSORB™ granulated activated carbon (GAC) was constructed to test for the adsorption of PFAS compounds. A sample of 20×40 CARBSORB™ GAC was prepared as described in Example 1. A sample of 12×40 CARBSORB™ GAC was prepared using the same method as described in Example 2.

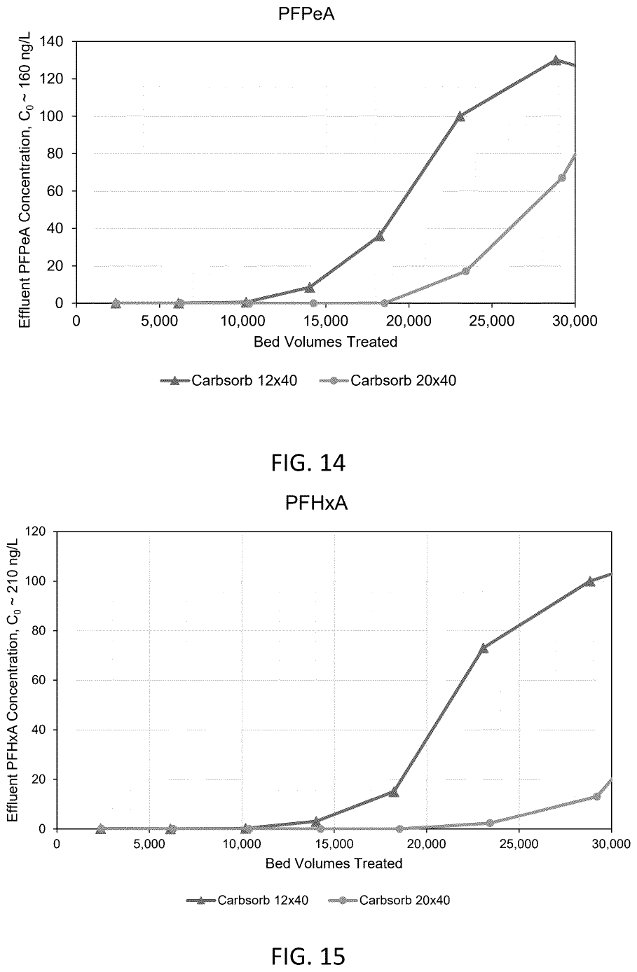

A PFAS adsorption test was performed using a pilot column to generate a PFPeA breakthrough curve. The inlet concentration of PFPeA was about 160 ng/L, and data was logged to yield a breakthrough curve. Breakthrough was measured as the concentration in ng/L that broke through a column of 12×40 GAC or 20×40 GAC. FIG. 14 displays the measured amounts of PFPeA in the water. The results of the testing show a clear improvement in the number of beds to breakthrough the 20×40 GAC as compared to the 12×40 GAC. The 20×40 GAC had an initial breakthrough at about 23,400 bed volumes while the 12×40 GAC had an initial breakthrough at about 14,000 bed volumes.

### Example 14: Removal of PFHxA

A column of CARBSORB™ granulated activated carbon (GAC) was constructed to test for the adsorption of PFAS compounds. A sample of 20×40 CARBSORB™ GAC was prepared as described in Example 1. A sample of 12×40 CARBSORB™ GAC was prepared using the same method as described in Example 2.

A PFAS adsorption test was performed using a pilot column to generate a PFHxA breakthrough curve. The inlet concentration of PFHxA was about 210 ng/L, and data was logged to yield a breakthrough curve. Breakthrough was measured as the concentration in ng/L that broke through a column of 12×40 GAC or 20×40 GAC. FIG. 15 displays the measured amounts of PFHxA in the water. The results of the testing show a clear improvement in the number of beds to breakthrough the 20×40 GAC as compared to the 12×40 GAC. The 20×40 GAC had an initial breakthrough at about 23,400 bed volumes while the 12×40 GAC had an initial breakthrough at about 14,000 bed volumes.

### Example 15: Removal of PFHpA

A column of CARBSORB™ granulated activated carbon (GAC) was constructed to test for the adsorption of PFAS compounds. A sample of 20×40 CARBSORB™ GAC was prepared as described in Example 1. A sample of 12×40 CARBSORB™ GAC was prepared using the same method as described in Example 2.

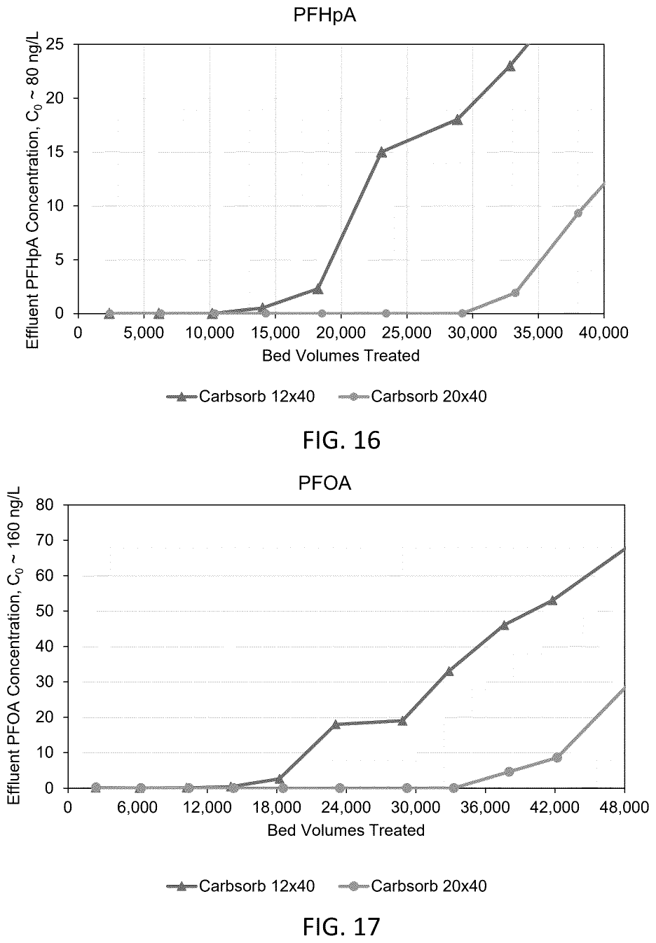

A PFAS adsorption test was performed using a pilot column to generate a PFHpA breakthrough curve. The inlet concentration of PFHpA was about 80 ng/L, and data was logged to yield a breakthrough curve. Breakthrough was measured as the concentration in ng/L that broke through a column of 12×40 GAC or 20×40 GAC. FIG. 16 displays the measured amounts of PFHpA in the water. The results of the testing show a clear improvement in the number of beds to breakthrough the 20×40 GAC as compared to the 12×40 GAC. The 20×40 GAC had an initial breakthrough at about 33,000 bed volumes while the 12×40 GAC had an initial breakthrough at about 14,000 bed volumes.

### Example 16: Removal of PFOA

A column of CARBSORB™ granulated activated carbon (GAC) was constructed to test for the adsorption of PFAS compounds. A sample of 20×40 CARBSORB™ GAC was prepared as described in Example 1. A sample of 12×40 CARBSORB™ GAC was prepared using the same method as described in Example 2.

A PFAS adsorption test was performed using a pilot column to generate a PFOA breakthrough curve. The inlet concentration of PFOA was about 160 ng/L, and data was logged to yield a breakthrough curve. Breakthrough was measured as the concentration in ng/L that broke through a column of 12×40 GAC or 20×40 GAC. FIG. 17 displays the measured amounts of PFOA in the water. The results of the testing show a clear improvement in the number of beds to breakthrough the 20×40 GAC as compared to the 12×40 GAC. The 20×40 GAC had an initial breakthrough at about 38,000 bed volumes while the 12×40 GAC had an initial breakthrough at about 18,000 bed volumes.

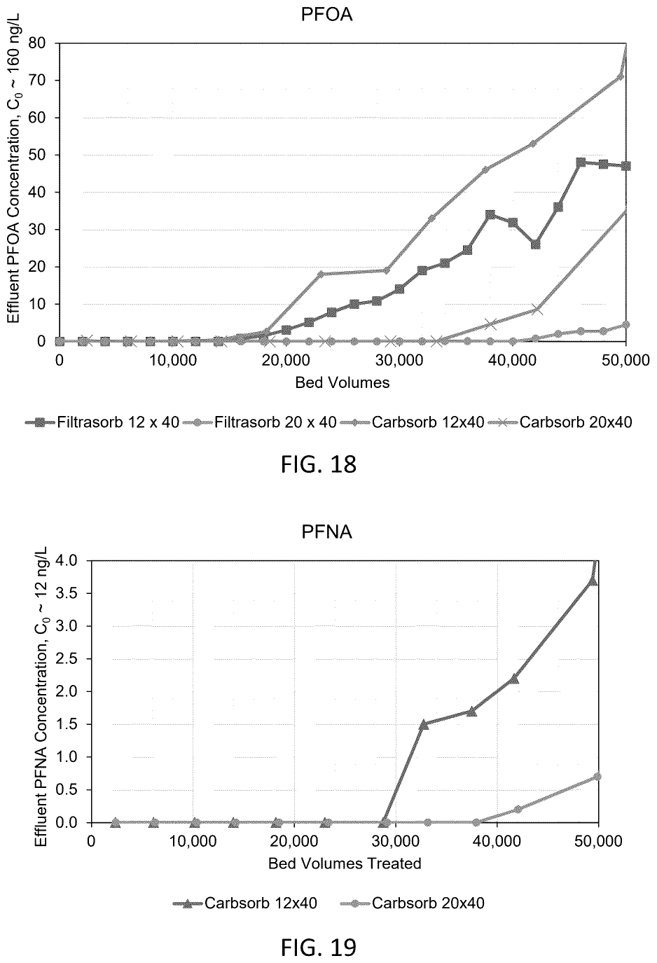

FIG. 18 displays an overlay of the results of the PFOA breakthrough testing for the CARBSORB™ carbon and the FILTRASORB 400 using the mesh sizes of 12×40 and 20×40. The results of the testing clearly show the improvement in the breakthrough of the PFOA when using the 20×40 GAC as compared to the 12×40 GAC. The results show that each of the 20×40 F400 GAC and the 20×40 CARBSORB™ GAC outperformed the 12×40 F400 GAC and the 12×40 CARBSORB™ GAC samples. This shows the improvement provided by the use of 20×40 GAC in PFAS removal as compared to larger sorbent materials.

### Example 17: Removal of PFNA

A column of CARBSORB™ granulated activated carbon (GAC) was constructed to test for the adsorption of PFAS compounds. A sample of 20×40 CARBSORB™ GAC was prepared as described in Example 1. A sample of 12×40 CARBSORB™ GAC was prepared using the same method as described in Example 2.

A PFAS adsorption test was performed using a pilot column to generate a PFNA breakthrough curve. The inlet concentration of PFNA was about 12 ng/L, and data was logged to yield a breakthrough curve. Breakthrough was measured as the concentration in ng/L that broke through a column of 12×40 GAC or 20×40 GAC. FIG. 19 displays the measured amounts of PFNA in the water. The results of the testing show a clear improvement in the number of beds to breakthrough the 20×40 GAC as compared to the 12×40 GAC. The 20×40 GAC had an initial breakthrough at about 42,000 bed volumes while the 12×40 GAC had an initial breakthrough at about 32,700 bed volumes.

### Example 18: Removal of PFBS

A column of CARBSORB™ granulated activated carbon (GAC) was constructed to test for the adsorption of PFAS compounds. A sample of 20×40 CARBSORB™ GAC was prepared as described in Example 1. A sample of 12×40 CARBSORB™ GAC was prepared using the same method as described in Example 2.

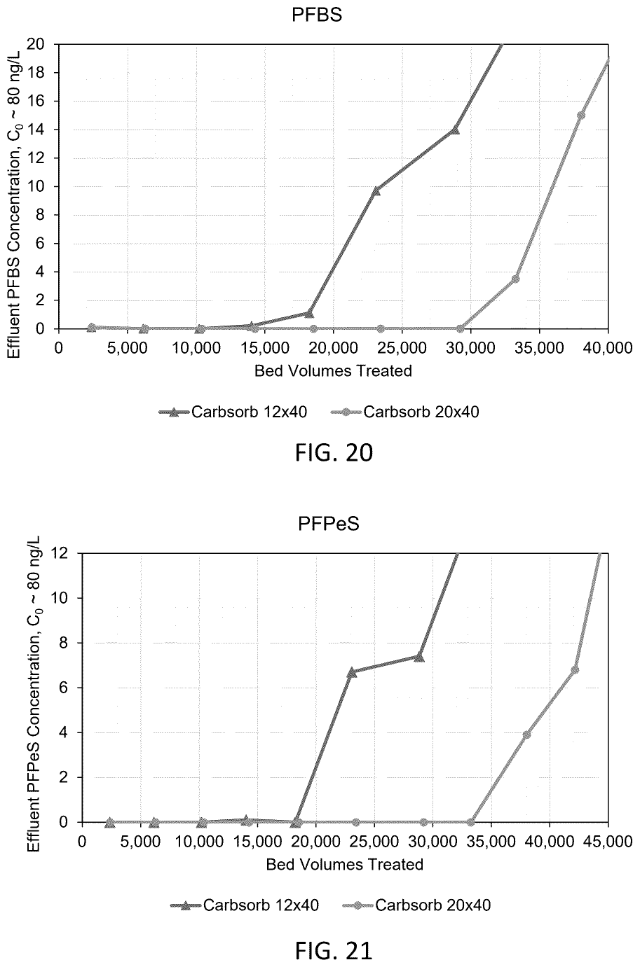

A PFAS adsorption test was performed using a pilot column to generate a PFBS breakthrough curve. The inlet concentration of PFBS was about 80 ng/L, and data was logged to yield a breakthrough curve. Breakthrough was measured as the concentration in ng/L that broke through a column of 12×40 GAC or 20×40 GAC. FIG. 20 displays the measured amounts of PFBS in the water. The results of the testing show a clear improvement in the number of beds to breakthrough the 20×40 GAC as compared to the 12×40 GAC. The 20×40 GAC had an initial breakthrough at about 33,000 bed volumes while the 12×40 GAC had an initial breakthrough at about 18,000 bed volumes.

### Example 19: Removal of PFPeS

A column of CARBSORB™ granulated activated carbon (GAC) was constructed to test for the adsorption of PFAS compounds. A sample of 20×40 CARBSORB™ GAC was prepared as described in Example 1. A sample of 12×40 CARBSORB™ GAC was prepared using the same method as described in Example 2.

A PFAS adsorption test was performed using a pilot column to generate a PFPeS breakthrough curve. The inlet concentration of PFPeS was about 80 ng/L, and data was logged to yield a breakthrough curve. Breakthrough was measured as the concentration in ng/L that broke through a column of 12×40 GAC or 20×40 GAC. FIG. 21 displays the measured amounts of PFPeS in the water. The results of the testing show a clear improvement in the number of beds to breakthrough the 20×40 GAC as compared to the 12×40 GAC. The 20×40 GAC had an initial breakthrough at about 38,000 bed volumes while the 12×40 GAC had an initial breakthrough at about 23,000 bed volumes.

### Example 20: Removal of PFHxS

A column of CARBSORB™ granulated activated carbon (GAC) was constructed to test for the adsorption of PFAS compounds. A sample of 20×40 CARBSORB™ GAC was prepared as described in Example 1. A sample of 12×40 CARBSORB™ GAC was prepared using the same method as described in Example 2.

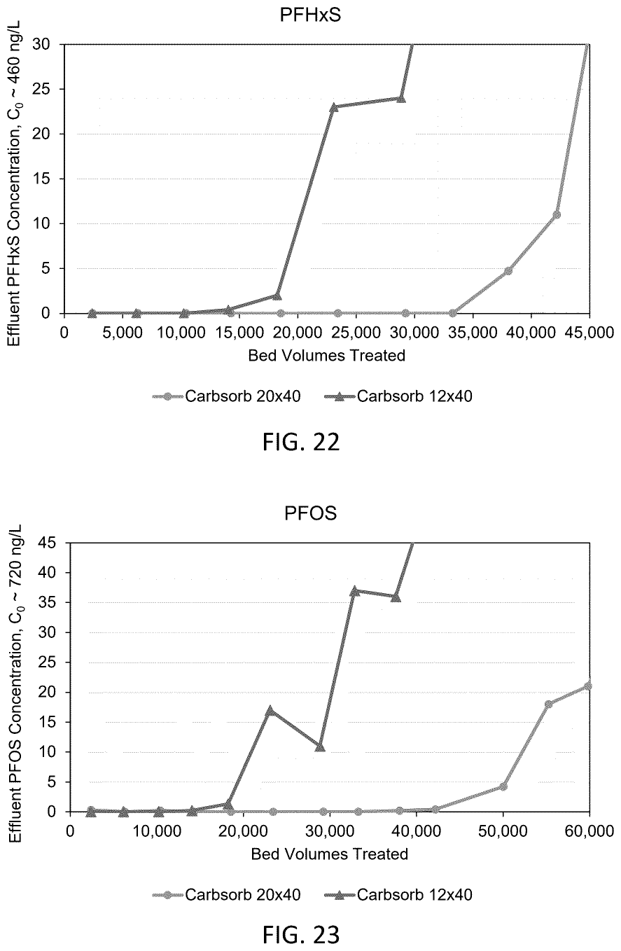

A PFAS adsorption test was performed using a pilot column to generate a PFHxS breakthrough curve. The inlet concentration of PFHxS was about 460 ng/L, and data was logged to yield a breakthrough curve. Breakthrough was measured as the concentration in ng/L that broke through a column of 12×40 GAC or 20×40 GAC. FIG. 22 displays the measured amounts of PFHxS in the water. The results of the testing show a clear improvement in the number of beds to breakthrough the 20×40 GAC as compared to the 12×40 GAC. The 20×40 GAC had an initial breakthrough at about 38,000 bed volumes while the 12×40 GAC had an initial breakthrough at about 18,000 bed volumes.

### Example 21: Removal of PFOS

A column of CARBSORB™ granulated activated carbon (GAC) was constructed to test for the adsorption of PFAS compounds. A sample of 20×40 CARBSORB™ GAC was prepared as described in Example 1. A sample of 12×40 CARBSORB™ GAC was prepared using the same method as described in Example 2.

A PFAS adsorption test was performed using a pilot column to generate a PFOS breakthrough curve. The inlet concentration of PFOS was about 720 ng/L, and data was logged to yield a breakthrough curve. Breakthrough was measured as the concentration in ng/L that broke through a column of 12×40 GAC or 20×40 GAC. FIG. 23 displays the measured amounts of PFOS in the water. The results of the testing show a clear improvement in the number of beds to breakthrough the 20×40 GAC as compared to the 12×40 GAC. The 20×40 GAC had an initial breakthrough at about 50,000 bed volumes while the 12×40 GAC had an initial breakthrough at about 18,000 bed volumes.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

What is claimed is:

1. A method of removing perfluoroalkyl and polyfluoroalkyl substances (PFAS) from liquid or gas, the method comprising:
providing a sorbent material having a particle size between 0.4 mm and 0.85 mm; and
contacting the sorbent material with a liquid or gas containing the PFAS.

2. The method of claim 1, wherein the sorbent material comprises one or more of carbonaceous char, activated carbon, reactivated carbon, and carbon black.

3. The method of claim 1, wherein the sorbent material is formed from one or more of bituminous coal, sub-bituminous coal, lignite coal, anthracite coal, wood, wood chips, sawdust, peat, nut shells, pits, coconut shell, babassu nut, macadamia nut, dende nut, peach pit, cherry pit, olive pit, walnut shell, wood, lignin, polymers, nitrogen-containing polymers, resins, petroleum pitches, bagasse, rice hulls, corn husks, wheat hulls and chaff, graphenes, carbon nanotubes, or polymer fibers.

4. The method of claim 1, wherein the sorbent material comprises an iodine number greater than 1000 mg/g.

5. The method of claim 1, wherein the sorbent material comprises an iodine number of at least 1030 mg/g.

6. The method of claim 1, wherein the sorbent material comprises a molasses number of at least 175.

7. The method of claim 1, wherein the sorbent material comprises an apparent density of less than 0.58 g/cc.

8. The method of claim 1, wherein the sorbent material comprises a D50 particle size of 0.6 mm to 0.7 mm.

9. The method of claim 1, wherein the sorbent material is provided as a granular activated carbon, the method further comprising screening the granular activated carbon using a 20 US mesh and a 40 US mesh.

10. The method of claim 1, wherein the PFAS comprise one or more of perfluorobutanoic acid, perfluoropentanoic acid, perfluorohexanoic acid, perfluoroheptanoic acid, perfluorooctanoic acid, and perfluorononanoic acid.

11. The method of claim 1, wherein the PFAS comprise one or more of perfluorobutane sulfonate, perfluoropentane acid, perfluorohexane sulfonate, perfluoroheptane sulfonate, and perfluorooctane sulfonate.
